(19) United States
(12) Patent Application Publication
(10) Pub. No.: US 2024/0076884 A1
(43) Pub. Date: Mar. 7, 2024

(54) CONCRETE TOOL ASSEMBLY AND METHOD OF FORMING ASSEMBLY

(71) Applicant: Baron Innovative Technology LP, Oxnard, CA (US)

(72) Inventor: Anthony Baratta, Oak Park, CA (US)

(73) Assignee: Baron Innovative Technology LP, Oxnard, CA (US)

(21) Appl. No.: 18/139,910

(22) Filed: Apr. 26, 2023

Related U.S. Application Data
(63) Continuation-in-part of application No. PCT/US23/10441, filed on Jan. 10, 2023.
(60) Provisional application No. 63/335,721, filed on Apr. 27, 2022.

(51) Int. Cl. E04F 21/165; C09J 5/00; C09J 7/22; C09J 7/35; C09J 7/38

(52) U.S. Cl. CPC E04F 21/165; C09J 5/00; C09J 7/22; C09J 7/35; C09J 7/38; E01C 19/44

(57) ABSTRACT

A film coating or laminate on a surface of a concrete finishing tool, including a film covering a surface, or including a film spanning a space between two surfaces, including for example a film for covering a channel on such tools, and methods relating thereto.

### BACKGROUND

### Field

These inventions relate to a film coating or laminate on a surface of a concrete finishing tool, including a film covering a surface, a film or laminate covering a surface of such a tool from one edge to an opposite edge, including a film spanning a space between two surfaces, including for example a film for covering a channel on such tools, and methods relating thereto. They also relate to a film coating or laminate on a surface of a concrete finishing tool extending to an edge of the tool and further having an edge protector.

### SUMMARY

In one example of a concrete finishing tool, the tool includes a longitudinally extending tool element having a finishing surface, for example a substantially flat or slightly curved finishing surface, and an opposite or upper surface, for example to which a control element such as a pivot and handle would be attached for operating the tool. A film extends over at least a portion of the opposite surface. In one example, the film extends over at least 50% of the opposite surface, including for example over raised portions, and in another example the film extends over at least part of a channel to cover or close an upper portion of the channel, for example. In a further example, the film extends over substantially all portions of a channel on the opposite surface except for an interface for a pole or pivot attachment. In an additional example, the film extends over exposed surfaces of the opposite surface, and in a further example substantially all of the opposite surface, and in a still further example substantially all of the opposite surface except for that portion of the upper surface occupied by a tool interface and/or a channel for the tool interface. The finishing surface may include longitudinally extending secondary finishing elements such as a cutting surface, a ramp surface and/or other surfaces, and in such instances, the local or adjacent opposite or upper surface would extend in substantially the opposite direction of the secondary finishing surface though not necessarily perpendicular to an adjacent concrete surface when the tool is flat on a concrete surface. Additionally, the film or an additional film may extend over part or all of the finishing surface.

In another example of a concrete finishing tool, the tool includes a longitudinally extending tool element having a finishing surface, for example a substantially flat or slightly curved finishing surface for finishing concrete, and an opposite or upper surface for receiving a plastic film cover, for example a vinyl film cover. In one example, the plastic film cover extends over at least part of a surface of the opposite or upper surface of the tool. In another example, the plastic film contacts a plurality of spaced apart surfaces on the tool forming a cover over a cavity on the tool. In a further example, the plastic film contacts a plurality of spaced apart surfaces on the tool extending longitudinally from approximately an end surface of the tool to a pivot attachment location for the tool. In an additional example, the plastic film follows a surface profile in the upper surface of the tool, and in one example the film covers a surface profile having one or more raised portions and flat portions on each side of the one or more raised portions. In a further example, the plastic film extends over more than 50% of the upper surface of the tool, and in one example the film covers a plurality of raised portions and a plurality of flat portions on each side of the plurality of raised portions totaling more than 50% of the upper surface. In an additional example the plastic film extends over substantially all of the upper surface or over substantially all except for a channel for one or more attachments, for example except for an area for a pivot attachment or interface for the tool. In an additional example, the tool includes a pressure and/or heat activated adhesive backed plastic film.

In examples described herein of a tool with a film, the combination can be a tool and a laminated film, namely a multiple layer film on the tool. For example, the film can be a film laminate having a plastic film having adhesive and printing or other opaque or color application, and/or protective film, for example a UV or other protective film.

In an example of a film cover element for a concrete finishing tool, a film has a border having a profile approximating a profile of a concrete finishing tool. In one example, the film is a vinyl film, and in a further example is a pressure and/or heat activated adhesive backed vinyl. In another example, the film includes a wall defining an opening configured to accommodate a tool interface to extend into the opening.

In a further example of a cover element for a concrete finishing tool, including any of the concrete finishing tools identified herein, the tool can include a film on an upper surface of the tool wherein the film extends from one edge to another edge, for example from a first edge to an opposite edge. In one example, the film extends from one side edge of the tool to an opposite side edge of the tool. In another example, the film extends from a forward or leading edge of the tool to a rear or trailing edge of the tool. The film can also extend both to the side edges of the tool and the leading and trailing edges of the tool. In any of the examples herein, the film may cover one or more raised portions and flat portions on each side of the one or more raised portions. The film can protect the upper surface of the tool, and can make cleaning the tool easier.

In another example of a concrete finishing tool, including any of the concrete finishing tools identified herein, the concrete finishing tool extends longitudinally and includes side edges and front and rear edges, a film on an upper surface of the tool such as described herein, and at least one of the edges includes an edge protector. In one example, the edge protector is an end cap or a plurality of end caps, such as may be placed on side surfaces of the tool, and in another example, the edge protector extends on one or more of the front and rear edges of the tool. In a further example, where a film extends to all edges around a perimeter of the tool, each of the edges includes an edge protector. In a further configuration where the tool includes exposed interior edges interior to the perimeter of the tool, such as may be formed by a channel, the edges of the channel can be protected with respective edge protectors, in one example a channel cover.

In an example of a method of placing a film on a concrete finishing tool, a plastic film, for example a vinyl film, is placed against a surface of the concrete finishing tool with adhesive between the vinyl film and the surface of the concrete finishing tool. The film can then be finished, if desired. In one example of finishing the film on the tool, the film is pressed, heated and/or stretched. In another example of finishing the film on the tool, pressure is applied to the film, and in one example, pressure is applied to the film using a blade, for example to flatten the film. In one example of finishing, a squeegee is moved across a surface of the film.

In a further example of a method of placing a film on a concrete finishing tool, a backing layer is a removed from an adhesive on the film and the adhesive side of the film is applied to a surface on the concrete finishing tool. In one example, the film is applied to a plurality of spaced apart surfaces on the tool, or in another example the film is applied to a substantially flat surface on the tool. In a further example, the film is applied to a plurality of spaced apart surfaces on the tool to cover a channel formed between the spaced apart surfaces, and in an alternative example, the film is applied to each of the spaced apart surfaces up to respective edges on opposite sides of the channel without extending over an opening forming the channel. In an additional example, the film is placed over substantially all of an upper surface of the tool except for at least a portion for an adapter for a pivot or other control element for the tool.

In another example of a method of placing a film on a concrete finishing tool, for example any of the films described herein, the film is placed against a surface of the tool and extends from a first edge to a second edge. In one example, the film extends from a first edge to a second edge opposite the first edge. In a further example, the film extends to all edges around a perimeter of the tool. In one example, the film extends to side edges of the tool and to forward and rearward edges of the tool. Where the tool includes edges defining a discontinuity in the upper surface of the tool within the perimeter of the tool, such as a channel, the film can extend from edges at the perimeter of the tool up to an edge defining the discontinuity, and may stop there or may cover the discontinuity, for example cover the channel.

In any of the examples of a method described herein, the method can include cutting the film from a sheet of film, for example a sheet of vinyl film, and in a further example a sheet of pressure and/or heat activated adhesive backed vinyl. Also in any of the examples of a method described herein, the method can include printing ink on the film, such as printing ink on a vinyl film.

In another example of a method for a film for a concrete finishing tool, the method includes cutting film to approximate a shape of a concrete finishing tool. In one example, the film is cut to approximate the shape of the concrete finishing tool including cutting an opening to accommodate a tool attachment, such as an adapter or tool interface, for example for a pivot or handle control element. In one example of such cutting of film, the cutting of film can be cutting of a pressure and/or heat activated adhesive backed vinyl.

In any of the examples of a method described herein, the method can include applying edge protectors to at least one edge of the tool to which a film extends. In one example, the tool having a film cover extending to an edge can have an edge protector covering the edge and an adjacent portion of the film. The edge protector can be an end cap, a rim cap or edge cap extending over an edge between the end caps, or a channel cover.

These and other examples are set forth more fully below in conjunction with drawings, a brief description of which follows.

### BRIEF DESCRIPTION OF THE DRAWINGS

FIG. 1 is a front right isometric view of a concrete finishing tool in the form of a float with a film covering a portion of an opposite or upper surface of the tool;

FIG. 2 is a detail of a middle portion of the tool of FIG. 1;

FIG. 3 is a detail of an end portion of the tool of FIG. 1 showing a plug;

FIG. 4 is an exploded view of the assembly of FIG. 1;

FIG. 5 is a transverse cross-section and detail of a portion of the tool of FIG. 1 showing the film covering a channel adjacent a tool adapter;

FIG. 6 is a schematic representation of steps for forming an assembly of a concrete finishing tool and a covering film;

FIG. 7 is a diametric and broken view of a further example of a tool assembly in the form of a float assembly with a film covering a portion of an opposite or upper surface of the tool;

FIG. 8 is a transverse cross-section of the tool assembly of FIG. 7 omitting rail guards;

FIG. 9 is a detail of a longitudinal cross-section of the tool of FIG. 7 showing a portion of the float, film and an end cap looking toward a rail from a point between the channel and the rail;

FIG. 10 is a detail of the cross-section taken at 10 of FIG. 8;

FIG. 11 is a detail of the cross-section taken at 11 of FIG. 8; and

FIG. 12 is a detail of the cross-section of an edge rail and edge rail protector for the tool of FIG. 7.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

These and other benefits will become more apparent with consideration of the description of the examples herein. However, it should be understood that not all of the benefits or features discussed with respect to a particular example must be incorporated into a tool, component or method in order to achieve one or more benefits contemplated by these examples. Additionally, it should be understood that features of the examples can be incorporated into a tool, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a number of tool configurations and of methods of making and using the tools are described herein, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

As used herein, “substantially” and “approximately” shall mean the designated parameter or configuration, plus or minus 10%. However, it should be understood that terminology used for orientation or relative position, such as front, rear, side, left and right, upper and lower, and the like, may be used in the Detailed Description for ease of understanding and reference, and are not necessarily used as exclusive terms for the structures being described and illustrated.

A concrete finishing tool having a cover on an upper surface of the tool provides protection for the tool during transportation and during use for limiting concrete from adhering to the surface. A cover can also be used for promotional, informational, or identification purposes, for example promoting a manufacturer, contractor, user or other supplier, or to identify the owner or for coding to identify the type of tool or other characteristic of the tool.

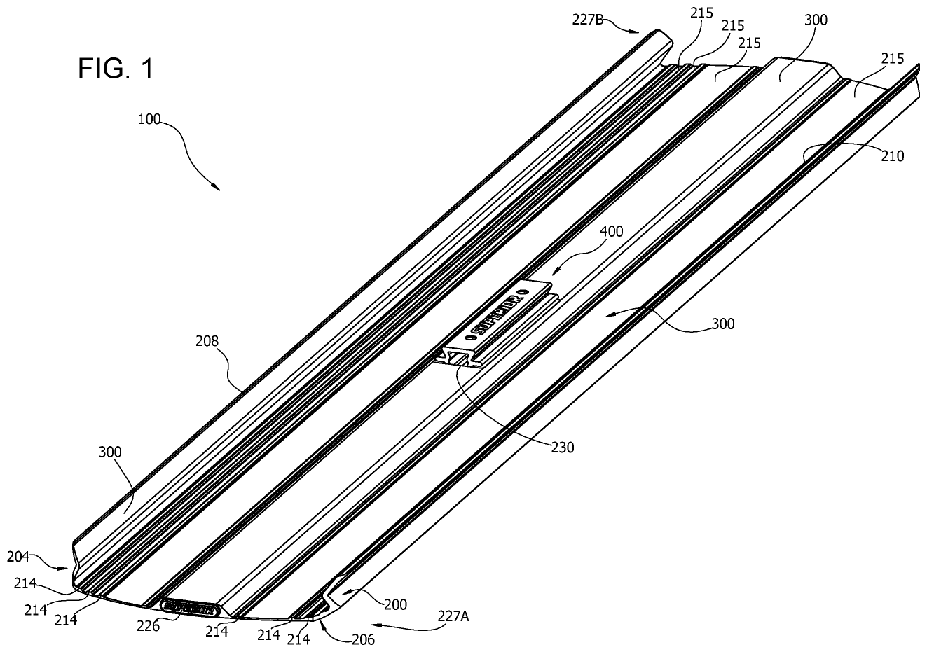

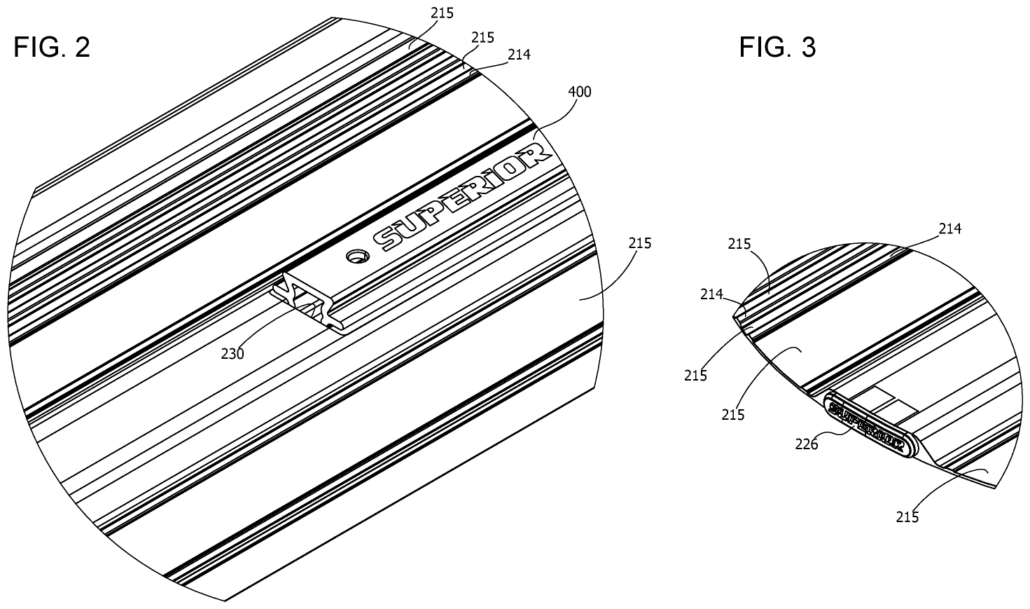

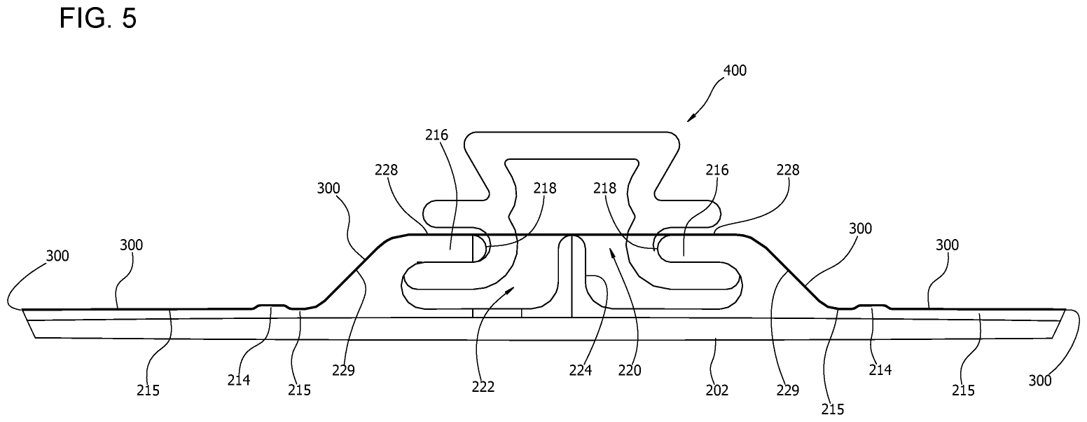

In one example of a concrete finishing tool having a film, an assembly 100 of a concrete finishing tool 200 and a film 300 (FIGS. 1-5) forms a float assembly for finishing a concrete surface. The float includes a finishing surface 202 (FIG. 5), which may be completely or substantially flat to form a planar portion of the float, or may be substantially planar with either a concave or convex configuration when viewed transverse to the longitudinal extent of the float, namely when viewed as represented by the direction of FIG. 5. The longitudinally extending end portions 204 and 206 (FIG. 1) may also include secondary finishing surfaces, even though such secondary finishing surfaces do not face perpendicular to a concrete surface when the finishing surface 202 is flat against the concrete surface. In the illustrated example, the longitudinally extending end portion 204 includes a cutting edge and the longitudinally extending end portion 206 includes a ramp and a cutting edge, where the cutting edge is substantially perpendicular to the adjacent finishing surface. The longitudinally extending end portions 204 and 206 have profiles that can be viewed transverse to the longitudinal extent of the float and the end portions extend to respective longitudinally extending edges 208 and 210. The finishing surface 202 and the adjacent surfaces of the longitudinally extending end portions 204 and 206 are considered to be on the same side of the float with each other.

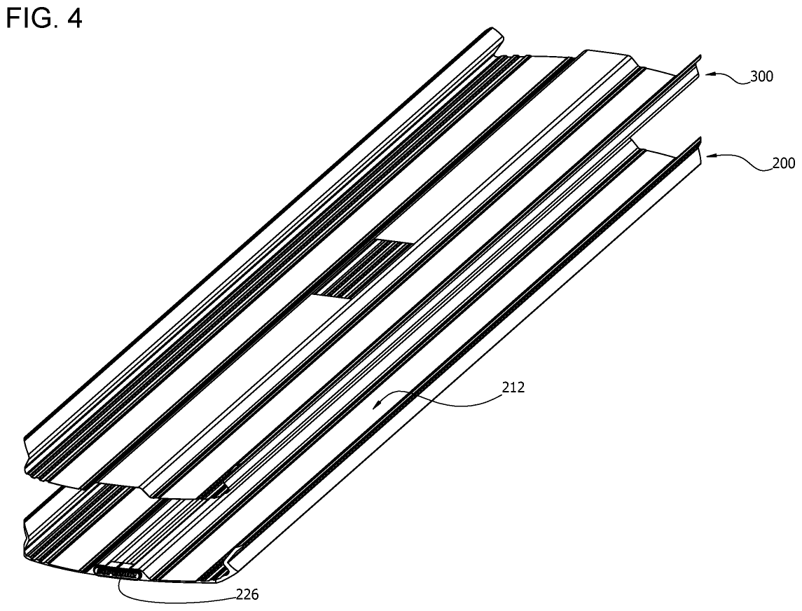

The float includes an opposite surface 212 (FIG. 4), which is considered to be a surface opposite the finishing surface 202 and opposite the surfaces of the adjacent longitudinally extending portions 204 and 206. The opposite surface 212 when the float is placed flat on a concrete surface faces predominantly away from the concrete surface. However, the portions of the opposite surface 212 that are locally in the area of the longitudinally extending end portions 204 and 206 are also considered opposite surfaces, to the extent that they are opposite the secondary finishing surfaces on the longitudinally extending end portions, even though such opposite surfaces may not extend away from and perpendicular to the concrete surface.

In the illustrated example, in addition to the longitudinally extending end portions, the float includes raised surfaces or raised portions, for example for reinforcing or strengthening the float, in the form of reinforcing or strengthening ribs 214 for supporting the structure of the float. The reinforcing ribs in the present example are formed during extrusion of the float 200. Other float configurations can have other surface geometries and configurations, but a film still can be applied to one or more surfaces of the float, to produce one or the configurations described herein in accordance with one or more of the methods described herein even though the underlying surface is not completely flat. In the configuration where the film covers more than 50% of the opposite surface 212, for example, the film covers one or more of the ribs 214, and also the flat portions 215 on each side of the ribs.

The illustrated float further includes mounting interface surfaces 216 (FIG. 5). The mounting interface surfaces are also formed during extrusion of the float, and therefore extend substantially the length of the float. The mounting interface surfaces reliably support an interface 400 (FIGS. 1-2 and 5). The interface 400 can be used to mount a pivot or other operating or control element, such as a handle assembly, for operating the float. Other interface configurations can be used to support the float.

The mounting interface surfaces 216 include respective end or edge surfaces 218 facing each other. The mounting interface surfaces extend longitudinally substantially the entire length of the float, and the end surfaces 218 define an opening 220 of a channel 222 (FIG. 5). The channel also extends substantially the entire length of the float. A flange or perpendicular wall or rib 224 extends upwardly from the opposite surface, and substantially bisects the channel 222. The wall 224 has a radiused top or end surface, having a radius of curvature approximately half the thickness of the wall 224. The radius of curvature can be greater or less than half the thickness of the wall, and the end of the wall can be substantially flat. In the illustrated example, the end of the wall and the outward or upward facing surfaces of the mounting interface surfaces 216 define a plane, but the end of the wall can extend beyond the plane, or be short enough to not break the plane.

The assembly can also include end caps or plugs 226 (FIGS. 1 and 3-4) fitting into respective ends of the channel 222. The plugs 226 help to limit intrusion of concrete or other material or liquids into the channel 222, for example from the longitudinal end portions of the float.

Alternative to the float described, the float for receiving a film can be any conventional float for finishing concrete. Additionally, the tool can take other forms for finishing concrete. Several examples include trowels, screeds and the like.

The film 300 in the assembly extends over at least a portion of the opposite surface of the float. In the present example, and as illustrated in FIGS. 1-5, the film 300 covers substantially all of the opposite surface 212 of the float, except for a rectangular portion allowing the interface 400 to extend through the opening in the film. In the present configuration, the film extends to longitudinal end surfaces of the interface, contacting such surfaces or substantially contacting the respective end surfaces. The long sides of the rectangular opening contact or substantially contact the adjacent longitudinally extending edge surfaces of the adapter 400. In the illustrated configuration, the film extends from side to side and from a front edge to a back edge, for example so that the film extends from a first side (for example the left side 227A) to a side opposite the first side (for example the right side 227B) and from the front edge 208 to the back edge 210 opposite the front edge.

As illustrated in FIG. 5, the film in the present example contacts upper surfaces 228 (FIG. 5) of the mounting interface surfaces 216. Also as illustrated, the film extends between the mounting interface surfaces 216, and in the present example covers substantially all of the channel 222 except for that portion occupied by the interface 400. The interface 400 can be considered as covering a portion of the channel, at least from the perspective of a plan view of the assembly. However, the film can cover less than substantially all of the channel 222, as desired. To the extent that the film covers the channel, the film helps to limit the intrusion of materials, such as concrete and/or fluids, which helps to reduce accumulation of residue or concrete adhering to surfaces in the channel.

In one configuration, the film is a vinyl film with an adhesive layer to fix the film to the adjacent surface of the float, in the present example, the opposite surface of the float. In one configuration, the film is a pressure and/or heat activated adhesive backed vinyl. One example is the 3M brand wrap film series 1080. The film can be a separate component sized as desired with a backing sheet to be removed for exposing the adhesive before the film is applied to the float. In one configuration, the film is cut so as to be configured for the desired size and shape for the opposite surface of the float for the extent of the surface to be covered, taking into account any changes in size from pressing, heating, stretching or application to the opposite surface, and accounting for an opening for the interface 400.

As illustrated in FIG. 5, the film 300 can extend across the upper surfaces 228 of the mounting interface surfaces 216 and down the sides 229 of the mounting interface surfaces. Though not illustrated, the film can terminate at the bottom portions of the sides. In the present configuration, the adhesive layer on the underside of the film contacts the adjacent surfaces of the opposite surface of the float, and secures or adheres the film to the adjacent surfaces. Moreover in a further example, also as illustrated in FIGS. 1-5, the film contacts and is adhered to substantially all of the opposite surface of the float, extending longitudinally of the float except for the interface 400 between left and right ends 227A and 227B, respectively, and transversely of the float between the first and second longitudinally extending edge portions 208 and 210. In one configuration, the film terminates at and does not contact the outwardly-facing sides of the side edge portions 227A and 227B that are between the finishing surface and the opposite surface. The film extends over and is adhered to the adjacent surfaces of the reinforcements 214, and to the adjacent surfaces of the opposite surfaces on the finishing elements 204 and 206. In the illustrated configuration in FIGS. 1-5, the film extends from edge to edge, for example one side edge 227A to the other, opposite side edge 227B (FIG. 1), and/or from one longitudinally extending edge portion 208 to the other longitudinally extending edge portion 210. In an example where the tool has edge portions interior to the perimeter, such as the edges 218 helping to define the opening 220 and the channel 222, the film may extend over the channel as illustrated in FIG. 5, or the film may be in multiple sections, such as a first film section extending between the side edges and from the one longitudinally extending edge portion 208 to the closest edge 218 of the channel, and from the other edge 218 to the other longitudinally extending edge portion 210. Alternatively, it is understood that the film can cover less than substantially all of the opposite surface, as desired, such as only that portion of the opposite surface opposite the substantially flat finishing surface in contact with the concrete surface when the float is flat on the concrete surface. Additionally or alternatively, it is understood that the film can cover less than all of the longitudinal extent of the opposite surface, as desired.

Film covering additional opposite surfaces beyond the mounting interface surfaces helps to protect such opposite surfaces and reduce accumulation of residue and/or concrete on such surfaces.

The film is applied to the opposite surface of the float according to the desired size and shape of the final film configuration. Film can be cut as desired to achieve the desired application, based on the selected film configuration, for example a pressure and/or heat activated adhesive backed vinyl, other vinyl film, non-PVC film or other plastic film. In one example of a film for use in covering or extending over all or a portion of a concrete finishing tool, for example all or a portion of an opposite surface of a concrete finishing tool, the film can be cut to a shape and size approximating the geometry of the concrete finishing tool. In the present example, the film has a shape and size approximating the geometry of the opposite surface of the float 200, taking into account the change in size and geometry after finishing, such as by pressing, heating, stretching and/or other application of the film to the float. For example, the film after finishing can extend longitudinally substantially the same length as the float, and have a width substantially the same as the surface distance including distance required to pass over the ridges 214 between the edges 208 and 210. Additionally, the film can but need not be pre-cut to include the opening 230 (FIG. 1). If not precut, the opening can be finish cut to the desired opening after at least part of the film is adhered to the float.

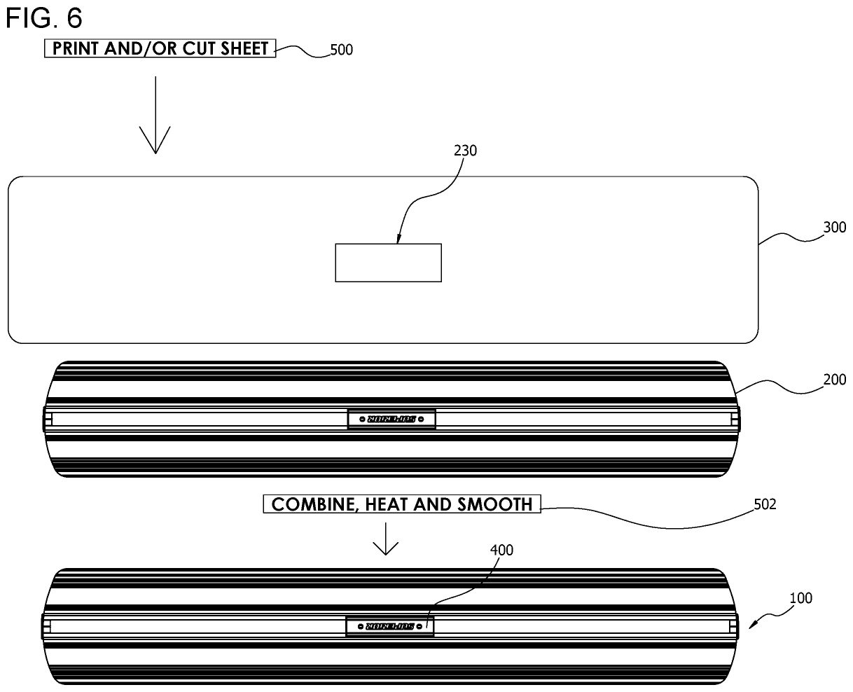

The film can be cut 500 (FIG. 6) with a digital plotter/cutter (not shown). If the film has no markings, indicia or color printed thereon, the film can simply be cut according to the desired geometry. If the film includes markings, indicia or color or other information or designations, the film can be printed with ink for such information or designations. The information or designations can include a company name, logo, distributor name or logo, owner name or logo, tool type designation, or other useful form of information. The printing can be done on a large-format digital printer and with UV stable inks. Additionally, once printed, the film can be thermally laminated with a clear protective film over the printed portion, for example with a gloss or matte protection layer, which may include UV protection or absorber. The combination of films would be termed a laminated film. The combination of a tool and a film will be termed a laminated tool, and a tool with a laminated film applied will be termed a compound laminated tool. The film then has the geometry as illustrated at 502 in FIG. 6. The geometry after cutting is selected so as to conform generally to the geometry of the opposite surface of the float to be covered, or to which the film is to be applied, taking into account the changes that will arise from finishing, such as pressing, heating, stretching and/or flattening.

The film will include an adhesive on a bonding surface of the film, which can be covered by a removable protective film. Alternatively, the film can be modified to include securement means for securing the film to the desired surface portions of the opposite surface of the float. In the present configuration illustrated in FIG. 6, the film 502 is slightly larger than the planar footprint of the float. The film and float can be finished 504 by combining the film and the float by placing the film against a desired surface of the float after removing any adhesive protective layer and if necessary positioning any opening 230 around the interface 400. For example, if desired, a portion of the film can be applied against the surfaces 228 of the interface engaging surfaces 216 so that the adjacent portion of the film contacts the surfaces 228 and adheres to those surfaces, and the adjacent portion of the film covers the channel 222. In the present example, or alternatively if the channel is not to be covered, the film 502 also includes sufficient material to cover the desired portions of the opposite surface of the float, and desired portions of the film can be placed on and adhered to the desired portions of the opposite surface of the float. The film can cover the flat spaces 215 on the float and also the ridges 214 to the desired extent. In one configuration, the film extends from the left side edge 227A to the right side edge 227B, for example within 1/16 to ¼ inch of the edge. Additionally or alternatively, the film extends from a forward or front edge to a rearward or back edge, corresponding to the rail portions of the secondary finishing portions 208 and 210, for example within 1/16 to ¼ inch of the edge. If the channel 222 is to be covered, the film extends completely from the forward or front edge to the rearward or back edge but for the area occupied by the interface 400. If the channel 222 is not to be covered, the film extends from the forward or front edge to the upper surface 228 bordering the channel, and from the opposite upper surface 228 to the back edge, for example within 1/16 to ¼ inch of the edge 218 of the channel opening. Where the film covers all of the opposite surface from the finishing surface, the film extends over the flat spaces 215 and over the ribs 214 is a continuous film, but for the area of the interface 400, and but for the channel opening 220 if the channel is not to be covered.

The film can be further finished 504 by being heated, such as with a heat gun or other heat source, pressed or stretched so as to assist in conforming the film to the surface geometry of the float, for example over the reinforcing ribs 214 and flat spaces 215 and against the opposite surfaces corresponding to the cutting edge portions 204 and 206. If desired or alternatively, the film can be further finished 504 by smoothing the film or flattening the film over the adjacent surfaces of the float. For example, the film can be flattened with a film squeegee or other suitable blade or straight edge for helping to flatten the film against the adjacent surfaces, removing or reducing any wrinkles, bubbles or other surface variations. In one example, the film is applied to the intended portion of the opposite surface of the float. The highest flat surface is finished with a squeegee, and then heat is applied to the film while flattening, stretching or otherwise finishing the film over the remaining surface, for example by squeegeeing with a squeegee, blade or straight edge or other appropriate tool. If desired, any exposed edge portions of the film can be trimmed.

Prior to cutting, a film or film laminate may be processed with a conventional film processing machine. In the example of a film, the film can be provided by the manufacturer on a suitable role or in another suitable form, and the film cut as desired and applied to the tool. In the example of a film to be printed or otherwise have a design or other matter printed thereon, such printing can be applied by a suitable printer, after which the film is placed on a roll or cut to the desired size for application to the tool. In the example of a film laminate, the film laminate can be supplied by the manufacturer on a suitable role or in another suitable form, or a conventional film processing machine can produce the laminate with an adhesive backed base layer, with or without printing or other image application and placed on a roll or other suitable carrier, and then laminated with one or more additional layers. An example additional layer may include an over laminate or other layer, which may include UV protection, and/or protection against liquids such as water, fuels, and other aqueous or organic liquids. Other layers may be included as desired to form the final film laminate to be applied to the tool.

A film can be applied to a tool, such as a float as illustrated herein, either after the float is manufactured and prior to shipment to a customer, or by a customer such as a reseller or by an end-user. If installed by a customer, the customer can be sent a precut film, and including if desired a vinyl squeegee or other finishing tool, and if desired a heat source.

The film may typically be installed after the target surface is clean and free of oil and debris, for example after wiping down with 99% isopropyl alcohol.

Other methods of applying a film include water transfer film, hydro-dipping, silkscreening and similar processes.

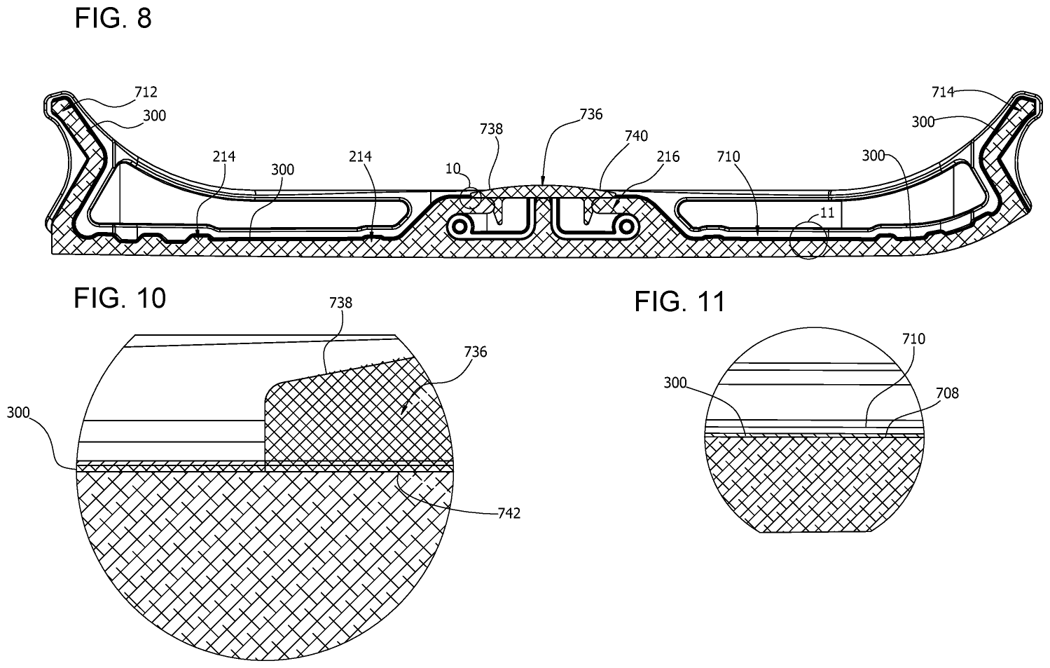

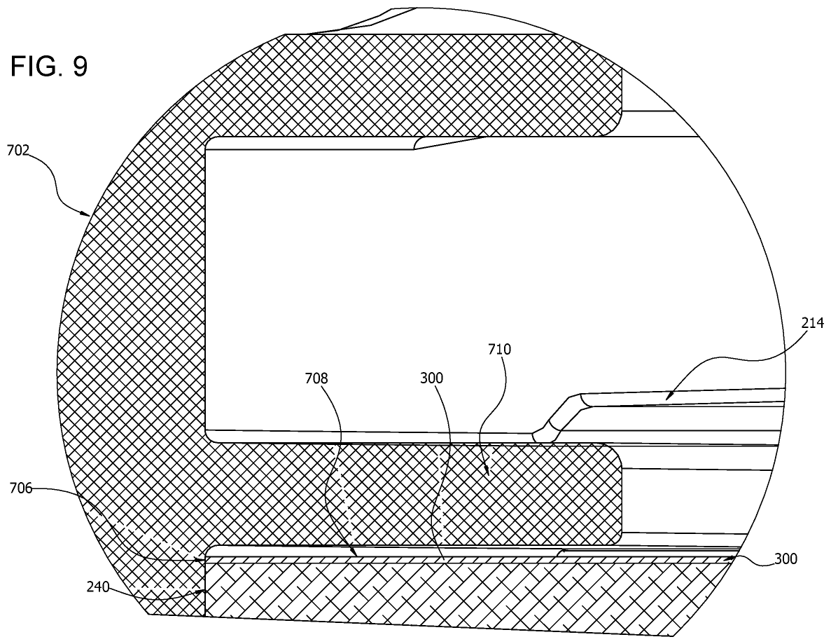

The laminated tool can include one or more edge protectors. An edge protector can help to protect a boundary of a lamination between a tool surface and a film adhered or otherwise secured to the tool. In examples illustrated herein, an edge protector can be any one or more of an end cap, rim or rail cap, cover or protector or channel cover. In a first example, a laminated float 700 (FIGS. 8-12) can include left and right end caps 702 and 704, respectively. In any of the examples described with respect to the float 700, the float assembly of a float and a film covering a portion of the float can include any one or more of end caps, rim caps, or channel covers, the use of which may be determined in part by whether or not a film extends to the area being protected by such edge protector. While the example of the float 700 is illustrated with all of the end caps, rim caps and channel covers, the float assembly need not include all of them, as desired. In the present example, the end caps are configured to cover the outwardly facing surfaces 240 (FIG. 9) of the float ends and also to cover the otherwise exposed edge 706 of the perimeter portions 708 of the film 300. In the illustrated example, the end caps are mirror images of each other, and each one includes covering portions 710 for covering edge or perimeter portions of the film, and support structures (not shown) including interference structures for helping to keep the end cap in place. In this example, the plugs 226 (FIG. 1) would be omitted. The end caps can be configured so that support structures 214 can provide an interference fit for reliably securing the end caps in place.

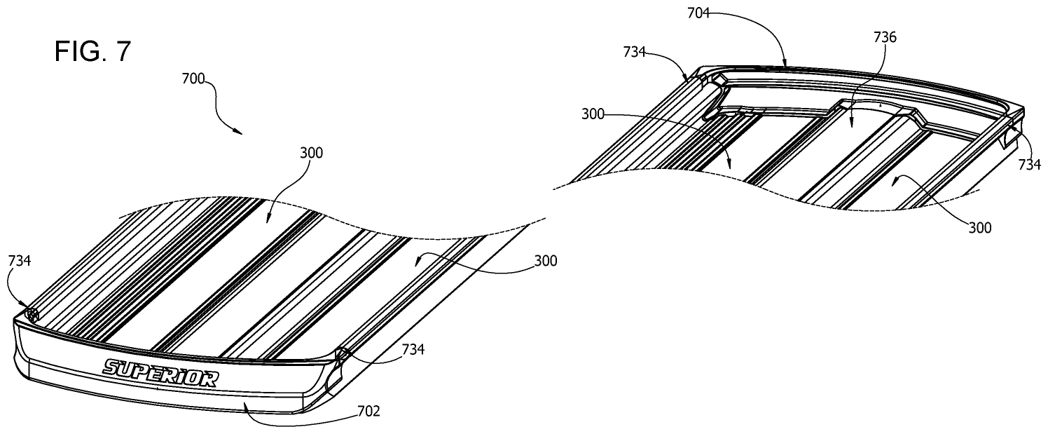

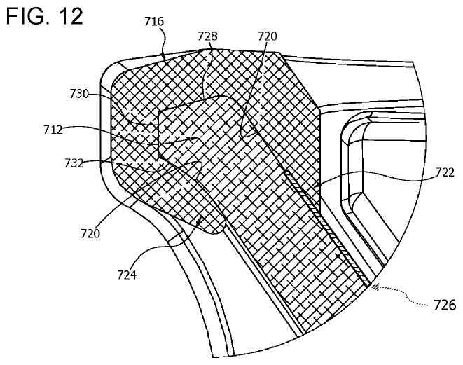

Other exposed perimeter edges of the float can be protected or covered with added materials, with or without the presence of end caps. In the illustrated configuration (FIGS. 7 and 12, the rail covers are not shown in FIG. 8 so that adjacent portions of the end caps are visible), protection by the end caps can be supplemented with protection of other perimeter edges of the float. In one example, the edge portions 208 and 210 include edge rails 712 and 714 (FIGS. 8 and 12) that extend longitudinally from one end of the float to the other end of the float and that may include rail protectors 716 and 718, respectively (FIGS. 7 and 12). Though they can be different, each rail protector is an identical mirror image of the other, and only one rail protector will be described further. The rail protector 716 includes an internal surface 720 that preferably conforms to the outer profile of the edge rails 712 or 714 on which it is placed. The outer surface of the protector can take any number of configurations. The rail protector 716 is formed as a channel, which in the illustrated configuration includes in cross section free end surfaces 722 and 724, and the free end surface 722 covers adjacent portions 726 of the film 300. The end surfaces are tapered, to reduce the size of the transition from the surface of the rail protector to the adjacent surface of the rail.

The rail protector forms as close a fit as possible to the rail edge. In one configuration, the rail protector is applied with an interference fit, in part by the edge rail having one or more discontinuous surfaces, such as those at 728, 730 and 732. Optionally, the edge rail and rail protector may include an additional securement material such as adhesive or the like, for example on the interior surface of the rail, to securely cover the surface and cover an edge of a portion 726 of film. The rail protector can be extruded from a suitable material and securely applied to the rail edge so that it can withstand normal use and cleaning on a construction site, including contact with or intrusion by water, wet concrete, impact from tools and the like, and pressure washing. Each rail protector 716 and 718 can be formed as a single piece or combined from multiple pieces. Multiple pieces can be installed discreetly or they may be bonded, glued, adhered, welded or otherwise fixed together on the rail edge. End portions 734 of the rail protector can also be formed integral with an end cap, or the rail protector can be bonded, glued, adhered or welded or otherwise secured to an end cap, to form a continuous protection against intrusion of material from the edges of the float.

The illustrated float assembly includes, in addition to or instead of one or more of the end caps and rail protectors, a channel cover 736 (FIGS. 7-8 and 10), while it is understood that other float configurations might not have structures forming edges interior to the perimeter of the float, and therefore not use any channel cover. In the present example, the film 300 is in at least first and second sections or portions, a first portion extending from a rail 208 across the raised portions 114 and flat portions 115 to the upper surface 228 and terminating at a film edge adjacent the channel edge 218. A second portion extends from the rail 210 across the raised portions 114 and flat portions 115 to the other upper surface 228 and terminating at a film edge adjacent the corresponding channel edge 218. The channel cover covers all or part of the channel 222, as desired, and helps to reduce the possibility of concrete, debris or other foreign material from entering the channel or from intruding under the channel cover, and under the adjacent edges of the film 300. The channel cover 736 or a plurality of channel covers in the present example extend the entire length of the float except for any portion or portions desired for accommodating a handle or pivot engagement structure or other means for helping to control or manipulate the float. The channel cover is formed so as to provide a reliable interference fit with the edges 218 of the mounting interface surfaces 216 of the channel, and may include respective overlay structures 738 and 740 over the upper surfaces of the surfaces 216 and over the adjacent edge portions 742 of the film 300 (FIG. 10), so that the overlay structures extend over underlying portions of a film perimeter 742 and preferably contact and sandwich the underlying perimeter film portion between it and the upper surface of the channel surfaces 216. The channel cover 736 may be press fit into the channel or slid longitudinally along the top of the channel to the desired position for covering an edge surface 742 or surfaces of the underlying film 300 or film sections.

In any of the methods described herein, edge protectors can be placed on the float assembly, as desired. In one example, the tool assembly can include left and right end caps 702 and 704 by fitting the end caps into complementary surfaces in the respective ends of the float. The end caps are applied so that the surfaces 710 cover the adjacent end or perimeter portions 708 of the film. Additionally or alternatively, rail protectors 716 and 718 are applied to the respective edge rails 712 and 714 and press fit onto the rails so that free end surfaces 722 can cover adjacent portions 726 of the film 300. Also additionally or alternatively, if the float includes a channel 222 with or without respective portions 742 of the film 300 extending adjacent the edges 218, a channel cover 736 is press fit into the channel or slid longitudinally along the top of the channel to the desired position for covering the channel and if present, the respective edge surfaces of the film sections.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

What is claimed is:

1. A concrete finishing tool comprising a longitudinally extending tool having a finishing surface and an opposite surface opposite the finishing surface, and a film extending over at least a portion of the opposite surface.

2. The tool of claim 1 wherein the film extends over at least 50% of the opposite surface.

3. The tool of claim 1 wherein the opposite surface includes first and second raised surfaces and wherein the film extends between the first and second raised surfaces.

4. The tool of claim 3 wherein the first and second raised surfaces form a channel between them and wherein the film covers at least a portion of the channel.

5. The tool of any of the preceding claims 1-4 wherein the opposite surface includes flat portions and raised portions, and wherein the film extends over the flat and raised portions.

6. The tool of claim 5 wherein the flat portions include first and second flat portions that extend on opposite sides of at least one of the raised portions, and the film extends over the at least one raised portion and over the first and second flat portions.

7. The tool of claim 1 wherein the film covers substantially all of the opposite surface.

8. The tool of claim 1 wherein the film covers substantially all of the opposite surface except for a tool interface.

9. The tool of claim 1 wherein the film is a vinyl.

10. The tool of claim 9 wherein the film is a pressure and/or heat activated adhesive backed vinyl.

11. The tool of any of the preceding claims 1-10 wherein the film extends to an edge region of the opposite surface and further including an edge protector on the edge region and extending over a portion of the film.

12. The tool of claim 11 wherein the edge protector is an end cap.

13. The tool of claim 11 wherein the edge protector is a channel cover.

14. The tool of claim 11 wherein the edge protector is an edge rail cover.

15. The tool of any of the preceding claims 1-14 wherein the film is a film laminate.

16. The tool of claim 15 wherein the film laminate includes a protective overlaminate.

17. The tool of any of the preceding claims 1-16 wherein the film includes a UV absorber.

18. The tool of any of the preceding claims 1-17 wherein the film includes an opaque area with an image.

19. The tool of any of the preceding claims 1-18 wherein the film includes text.

20. The tool of any of the preceding claims 1-19 wherein the film is a printable film.

21. The tool of any of the preceding claims 1-20 wherein the film extends to within ⅛ of an inch of a perimeter of edge surfaces of the tool.

22. The tool of any of the preceding claims 1-21 wherein the tool is a 70 concrete float.

23. The tool of any of the preceding claims 1-22 wherein the opposite surface extends to at least first and second edges and wherein the film extends substantially to the first and second edges.

24. The tool of claim 23 wherein the first and second edges are on opposite edges of the opposite surface.

25. The tool of claim 24 wherein the first and second edges are first and second side edges of the tool.

26. The tool of claim 24 wherein the first and second edges are an edge of the tool and an edge of an opening to a channel in the opposite surface.

27. The tool of any of the preceding claims 23-26 wherein the first edge includes a rail, and further including a protective bead on the rail.

28. The tool of claim 27 wherein the protective bead covers a portion of the film.

29. A method of placing a film on a concrete finishing tool, the method comprising placing a plastic film against a surface of the concrete finishing tool with adhesive between the plastic film and the surface of the concrete finishing tool and finishing the plastic film.

30. The method of claim 29 wherein placing the plastic film includes placing the plastic film to extend to a first edge region of the opposite surface and to a second edge region opposite the first edge region.

31. The method of claim 30 wherein placing the plastic film to extend to a first edge region includes placing the plastic film to extend to a lateral side edge of the tool.

32. The method of claim 30 wherein placing the plastic film to extend to a first edge region includes placing the plastic film to extend to an edge of a channel.

33. The method of claim 30 wherein placing the plastic film to extend to a first edge region includes placing the plastic film to extend to an edge rail.

34. The method of any of the preceding claims 29-33 wherein placing the plastic film places the plastic film over 50% of an upper surface of the concrete finishing tool.

35. The method of any of the preceding claims 29-34 wherein the concrete finishing tool surface includes flat portions and at least one raised portion and wherein placing the plastic film places the plastic film over at least one of the raised portions.

36. The method of any of the preceding claims 29-35 wherein placing the plastic film places the plastic film over substantially all of an upper surface of the concrete finishing tool opposite a finishing surface of the tool.

37. The method of any of the preceding claims 29-36 wherein finishing the plastic film includes heating the plastic film.

38. The method of claim 29-37 wherein finishing the plastic film includes applying a blade to a surface of the plastic film to flatten the plastic film.

39. The method of claim 38 wherein applying a blade includes using a squeegee against a surface of the plastic film.

40. The method of claim 29-39 including removing a backing from an adhesive layer on the plastic film.

41. The method of claim 29-40 further including cutting the plastic film from a sheet of plastic film.

42. The method of claim 29-41 further including printing ink on the plastic film.

43. The method of any of the preceding claims 29-42 wherein placing a plastic film includes placing the plastic film to extend to an edge region of the concrete finishing tool and further including applying an edge protector on the edge region to extend over a portion of the film.

44. The method of claim 43 wherein applying an edge protector includes applying an end cap to the tool.

45. The method of claim 43 wherein applying an edge protector includes applying a channel cover to a channel in the tool and covering a portion of the film with a portion of the channel cover.

46. The method of claim 43 wherein applying an edge protector includes applying an edge rail cover on an edge portion of the tool and covering a portion of the film.

47. The method of any of the preceding claims 29-46 wherein applying the film includes applying a film laminate.

48. The method of any of the preceding claims 29-47 wherein applying the film includes applying a protective overlaminate.

49. The method of any of the preceding claims 29-48 wherein applying the film includes applying a film having a UV absorber.

50. The method of any of the preceding claims 29-49 wherein applying the film includes applying the film having at least one of image and text on the film.

51. The method of any of the preceding claims 29-50 wherein applying the film includes applying the film to a float.

52. The method of any of the preceding claims 29-51 wherein applying the film includes applying the film to oppositely-facing surfaces on the film.
